(19) United States
(12) Patent Application Publication
(10) Pub. No.: US 2025/0330560 A1
(43) Pub. Date: Oct. 23, 2025

(54) TRANSPARENT PROJECTION DISPLAY SYSTEM WITH INTEGRATED BEHIND-DISPLAY CAMERA AND OPTICAL LAYERS FOR SELECTIVE IMAGE CAPTURE

(71) Applicant: Veeo Technology, Inc., San Diego, CA (US)

(72) Inventors: Ji Shen, San Diego, CA (US); Fenggang Wu, Las Vegas, NV (US); Martin Winston, Chagrin Falls, OH (US)

(73) Assignee: Veeo Technology, Inc., San Diego, CA (US)

(21) Appl. No.: 19/191,934

(22) Filed: Apr. 28, 2025

Related U.S. Application Data
(63) Continuation-in-part of application No. 18/642,421, filed on Apr. 22, 2024.
(60) Provisional application No. 63/639,453, filed on Apr. 26, 2024.
(60) Provisional application No. 63/657,799, filed on Jun. 8, 2024.

(51) Int. Cl. H04N 9/31; G03B 21/60

(52) U.S. Cl. CPC H04N 9/3179; G03B 21/60

(57) ABSTRACT

A transparent projection display system for video conferencing and collaborative communication is provided. The system comprises a transparent projection screen of clear material, a video projector configured to project images onto the front side of the screen, and a camera disposed behind the screen for capturing video of a user on the front side. To maximize the brightness of the projected image as viewed by the user while substantially preventing the camera from capturing the projected image transmitted through the screen, the system includes a reflective layer disposed on the front side of the projection screen and a microlouver film disposed on the rear side. The reflective layer is configured to reflect the projected image toward the user, and the microlouver film comprises an array of louvers that block transmission of the projected image to the camera except along a narrow viewing angle aligned with the camera's optical axis. This arrangement enables the camera to capture a clear user image through the screen while suppressing the capture of projected content, thus supporting natural, aligned eye contact and high-quality video communication.

### CROSS-REFERENCE TO RELATED APPLICATIONS

This patent application claims priority to and is a continuation-in-part of U.S. patent application Ser. No. 18/642,421, filed Apr. 22, 2024, and entitled “Video Conferencing Transparent Monitor with an Integrated Behind-Display Camera,” the entire disclosure of which is incorporated by reference herein. This patent application also claims priority to U.S. Provisional Patent Application No. 63/639,453, filed Apr. 26, 2024, and entitled “Video Conferencing Transparent Projection Screen with an Integrated Behind-Display Camera,” and U.S. Provisional Patent Application No. 63/657,799, filed Jun. 8, 2024, and entitled “Video Conferencing Transparent Projection Screen with an Integrated Behind-Display Camera,” the entire disclosures of which are incorporated by reference herein.

### BACKGROUND OF THE INVENTION

### 1. Field of Invention

The present invention relates to projection displays configured for video conferencing and collaborative communication. It features a transparent display screen with an integrated behind-display camera with selective reflective and transmission elements positioned to allow the camera to capture a clear user image through the display while substantially preventing the capture of projected content.

### 2. Description of Related Art

Video conferencing has become indispensable for business and personal communication, enabling remote participants to interact and collaborate in real-time. However, the conventional placement of webcams-typically at the display's top bezel results in a persistent misalignment between the user's line of sight and the camera. This misalignment causes participants to appear as if they are looking below or away from each other, undermining the sense of direct eye contact and diminishing the quality of virtual interactions.

To address this, there has been significant interest in integrating cameras behind or within the display so that the user's gaze aligns naturally with the camera. However, placing a camera directly in front of the display obstructs the screen content, while positioning it behind it introduces substantial technical challenges. Modern display technologies, such as TFT-LCDs and OLEDs, are constructed with millions of pixels and supporting circuitry that inherently limits transparency. Even so-called transparent OLED (T.OLED) displays, like those commercialized by LG Display, achieve only partial transparency and are unsuitable for high-fidelity video capture through the screen due to opaque pixel structures and supporting electronics.

Several companies have attempted to solve this problem. For example, Apple's U.S. Pat. No. 11,294,422 describes a display with regions of reduced pixel density to allow more light to pass through to a camera behind the screen. This approach results in a noticeable decrease in resolution in the camera region, which can degrade the user experience, especially if implemented at the center of the display where it would be most effective for eye contact. Similarly, Samsung's U.S. Pat. No. 9,001,184 discloses a system in which the display alternates between on and off periods, synchronizing these intervals with the camera's exposure to capture images when the display is “off” (i.e., displaying black frames). However, this technique is limited by the progressive, line-by-line refresh of modern displays, making it nearly impossible to achieve a moment when the entire screen is truly transparent for the camera. Moreover, even during these off periods, residual light from non-refreshed lines and the inherent opacity of display components can still interfere with image capture.

Other prior art systems, such as those described in U.S. Pat. No. 8,022,977, have attempted to use beamsplitters or partially transparent mirrors to allow a camera to capture the user's image while still displaying content. These systems, however, tend to be bulky, energy-inefficient, and prone to optical artifacts such as ghosting, Moiré patterns, and mesh distortions caused by the pixel grid structure of the display. Additionally, computational approaches attempting to correct these distortions are often complex, resource-intensive, and do not fully resolve the underlying optical issues, particularly under varying lighting conditions.

The persistent issues of ghost images, Moiré interference, mesh pattern distortion, and inadequate transparency continue to limit the effectiveness of behind-display camera systems. These challenges highlight the complexities of achieving clear, undistorted video capture through a digital display without compromising display quality or introducing distracting artifacts.

The lack of a comprehensive solution for behind-display camera integration in transparent displays underscores the need for an innovative system that balances transparency, luminance, and camera functionality. Such a system would significantly enhance the effectiveness and authenticity of video communication by ensuring that users maintain direct eye contact with remote participants, thus improving the overall quality and engagement of virtual interactions.

### SUMMARY OF THE INVENTION

The present invention overcomes these and other deficiencies of the prior art by providing a transparent projection display system specifically designed for video conferencing and collaborative communication. The system comprises a transparent display screen, a reflective layer on the front side of the screen, a microlouver film on the rear side, a video projector on the front side, and a camera aligned along the center axis behind the screen. The microlouver film includes an array of louvers, such as aerofoil-shaped or flat slat-shaped structures, which block light transmission at angles greater than 30 degrees relative to the center axis. This configuration prevents the projected image from being captured by the camera while allowing light from a user in front of the screen to pass through, enabling natural eye contact during video communication.

In an embodiment of the invention, a transparent projection display system comprises a display screen, a reflective layer disposed on a front side of the display screen, a microlouver film disposed on a rear side of the display screen, a video projector disposed on a front side of the display screen and configured to project an image onto the display screen, and a camera disposed behind the display screen and aimed along a center axis of the display screen. The microlouver film may comprise an array of louvers configured to block the transmission of light through the display screen at angles greater than 30 degrees relative to the center axis of the display screen. Additionally, the microlouver film substantially prevents transmission of the projected image to the camera while permitting transmission of light from a user positioned in front of the display screen. The microlouver film may provide a viewing angle of approximately 60 degrees centered about the center axis of the display screen. The louvers of the microlouver film may be aerofoil-shaped or flat slat-shaped. The louvers may be formed from a light-absorbing material. The projector may be oriented such that its optical axis is outside the 60-degree viewing angle of the microlouver film. The camera is configured to capture video of the user without capturing the projected image. The microlouver film may block at least 90% of light at angles greater than 30 degrees from the center axis.

In an embodiment of the invention, a method of operating a transparent projection display system comprises the steps of projecting an image onto a display screen using a video projector disposed on a front side of the screen, reflecting the projected image toward a user by a reflective layer disposed on a front side of the display screen, blocking transmission of the projected image through the display screen to a camera disposed behind the screen by providing a microlouver film on a rear side of the display screen, orienting the projector such that its optical axis is outside the viewing angle permitted by the microlouver film, and capturing, with the camera, an image of a user positioned in front of the display screen through the microlouver film, while substantially preventing the projected image from being captured by the camera. The microlouver film may have louvers selected from the group consisting of aerofoil louvers and flat slat louvers. The method may provide a viewing angle of approximately 60 degrees by the microlouver film. The camera may be aligned along the center axis of the display screen. The reflective layer may comprise a multilayer dielectric or metal or alloy coating. The method may further comprise embedding the captured image of the user with the projected content for video conferencing.

In an embodiment of the invention, a transparent projection display system comprises a display screen, a reflective layer disposed on a front side of the transparent display screen, a microlouver film disposed on a rear side of the transparent display screen, the microlouver film comprising louvers selected from the group consisting of aerofoil louvers and flat slat louvers, configured to block transmission of light at angles greater than 30 degrees from a center axis, a video projector disposed such that its optical axis is outside the viewing angle permitted by the microlouver film and configured to project an image onto the transparent display screen, and a camera disposed behind the transparent display screen and aligned along the center axis, the camera configured to capture an image of a user in front of the display screen while substantially preventing the capture of the projected image. The louvers may be formed from a light-absorbing material embedded in a transparent substrate. The microlouver film may be laminated onto the transparent display screen using an optically clear adhesive. The system may further comprise a controller configured to synchronize operation of the projector and the camera for video conferencing applications. The reflective layer may be configured to maximize the brightness of the projected image for the user while maintaining transparency for the camera.

The present invention offers several significant advantages over existing video conferencing and collaborative communication solutions. Integrating a behind-display camera with a transparent projection screen and employing a microlouver film enables natural, aligned eye contact during video interactions. This setup ensures that users appear to be looking directly at remote participants, enhancing the sense of presence and engagement in virtual meetings. Using a reflective layer and microlouver film allows for optimizing projected image brightness for the user while preventing the camera from capturing the projected content, thereby eliminating distracting artifacts and maintaining a clear view of the user. This configuration also supports a wide viewing angle, typically around 60 degrees, crucial for effective video communication. Additionally, the system's ability to suppress projected image bleed-through to the camera ensures high-quality video capture without compromising display performance. Overall, the invention significantly enhances the realism and effectiveness of remote communication, making it ideal for applications such as video conferencing, digital teleprompting, and collaborative virtual environments.

The foregoing and other features and advantages of the invention will be apparent from the following more detailed description of the invention's preferred embodiments, as shown in the accompanying drawings and the claims.

### BRIEF DESCRIPTION OF THE DRAWINGS

For a complete understanding of the present invention and its advantages, reference is now made to the ensuing descriptions taken in connection with the accompanying drawings briefly described as follows:

FIG. 1 illustrates a prior art system that uses alternating opaque and transparent display phases to synchronize with a camera's global shutter's opening and closing.

FIG. 2 illustrates a progressive line-by-line refreshing cycle of a display.

FIG. 3 illustrates a typical construct of a T.OLED pixel and the layout of opaque and transparent pixel sections.

FIG. 4 illustrates a microscopic view of the layout of pixels in a T.OLED display screen and the formation of a mesh pattern that distorts camera views.

FIG. 5 illustrates how the display's cover glass reflects the light emitted by the T-OLED pixels and creates a Moiré patterned interference and ghost image.

FIG. 5A is an unprocessed photo captured by a behind-display camera where the ghost image interferes with the camera image of the person in front.

FIG. 6 illustrates when a line of pixels' color is turned black, and there is no ghost image or Moiré pattern interference.

FIG. 6A is an image the behind-display camera captures when removing Moiré pattern interference.

FIG. 7 illustrates how the present invention synchronizes the progressive movement of a rolling shutter of a camera sensor with the progressive line-by-line refresh of the display in front of it.

FIG. 7A is an image the behind-display camera captures when Moiré pattern interference is removed.

FIG. 8A illustrates the present invention.

FIG. 8B illustrates the system of the present invention with input and output ports.

FIG. 9 illustrates the method of the Moiré pattern interference according to an embodiment of the invention.

FIG. 10 illustrates the method of removal of the distortion from a mesh pattern using spatial filtering.

FIG. 11 illustrates the details of the spatial filtering method of the present invention.

FIG. 12 illustrates the frequency domain pattern distribution of mesh interference after performing an FFT.

FIG. 13 illustrates formulating a bandpass filter in the frequency domain to remove a vertical mesh pattern interference according to an embodiment of the invention.

FIG. 14 illustrates formulating a bandpass filter to remove a slanted mesh pattern interference in the frequency domain.

FIG. 15 illustrates creating a correction image and the application of the correction image.

FIG. 15B is a processed photo after removing the Moiré and mesh pattern interference.

FIG. 16 illustrates the construction of a person and digital content embedded in a view image.

FIG. 17 illustrates the effect of disposing the behind-display camera at varying distances from the back of the display.

FIG. 18 illustrates a digital teleprompter with the system of the present invention.

FIG. 19 illustrates enabling the system of the present invention as a second monitor of an external content source device like a computer.

FIG. 20 illustrates the method of enabling the system of the current invention to connect to a host terminal device as a webcam.

FIG. 21 illustrates the video conferencing and collaborative communications system using a virtual glass-like shared glass board.

FIG. 22 illustrates the method using the system of the present invention for video conferencing and collaborative communications using a virtual glass-like shared glass board.

FIG. 23 illustrates a front projection transparent display system according to an embodiment of the invention.

FIG. 24 illustrates a rear projection transparent display system according to an embodiment of the invention.

FIG. 25 illustrates the front projection transparent display system of FIG. 23 with polarizers according to an embodiment of the invention.

FIG. 26 illustrates the rear projection transparent display system of FIG. 24 with polarizers according to an embodiment of the invention.

FIG. 27 illustrates a dispersion layer according to an embodiment of the invention.

FIG. 28 illustrates a front projection transparent display system according to another embodiment of the invention.

FIG. 29 illustrates different types of louvers that may be used in the microlouver film of the system of FIG. 28.

### DETAILED DESCRIPTION OF PREFERRED EMBODIMENTS

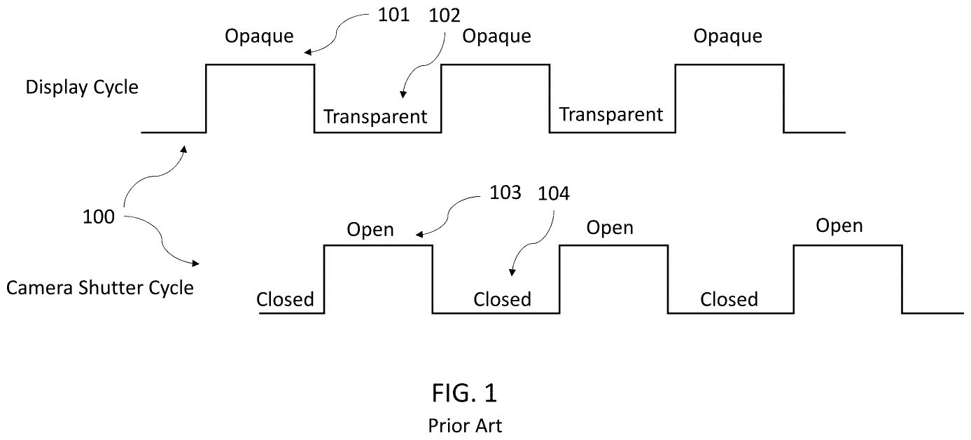

Preferred embodiments of the present invention and their advantages may be understood by referring to FIGS. 1-29. The described features, structures, or characteristics of the invention may be combined in any suitable manner in one or more embodiments. It will be apparent to those skilled in the art that various modifications can be made to the present invention without departing from its spirit and scope. Thus, the current invention is intended to cover modifications and variations consistent with the scope of the appended claims and their equivalents.

While the present invention is discussed in the context of capturing video of a person positioned in front of a transparent display, the present invention can be utilized without a person in front of the transparent display. As used herein, the scope of the term “transparent” includes semi-transparent. For example, the transparency of transparent OLED or T.OLED displays is forty percent (40%), but it is considered transparent. Accordingly, any present or future display portrayed as transparent is sufficiently transparent for use in the present invention, regardless of its actual degree of transparency. For this invention, a display with a transparency of fifteen percent (15%) or more is considered transparent.

The following detailed description sets forth various embodiments of the invention, which provide a transparent projection display system with an integrated behind-display camera for video conferencing and collaborative communication. The invention addresses the technical challenges of capturing high-quality, undistorted video through a transparent display or projection screen while preventing the camera from capturing the projected content, thereby enabling natural, aligned eye contact in remote interactions.

FIG. 1 illustrates a prior art technique for capturing video through a transparent display. In this technique, the display operates through cycles of opaque frames 101 when the active matrix of LEDs is on and transparent frames 102 when the active matrix is off, and the camera shutter goes through synchronized cycles of open shutter frames 103 and closed shutter frames 104. This makes it purportedly possible for the camera only to capture images when the display is in its transparent display mode. As it may seem reasonable in theory, that is not how displays work in practice. The inventors cannot find any commercially available displays that operate in such a manner.

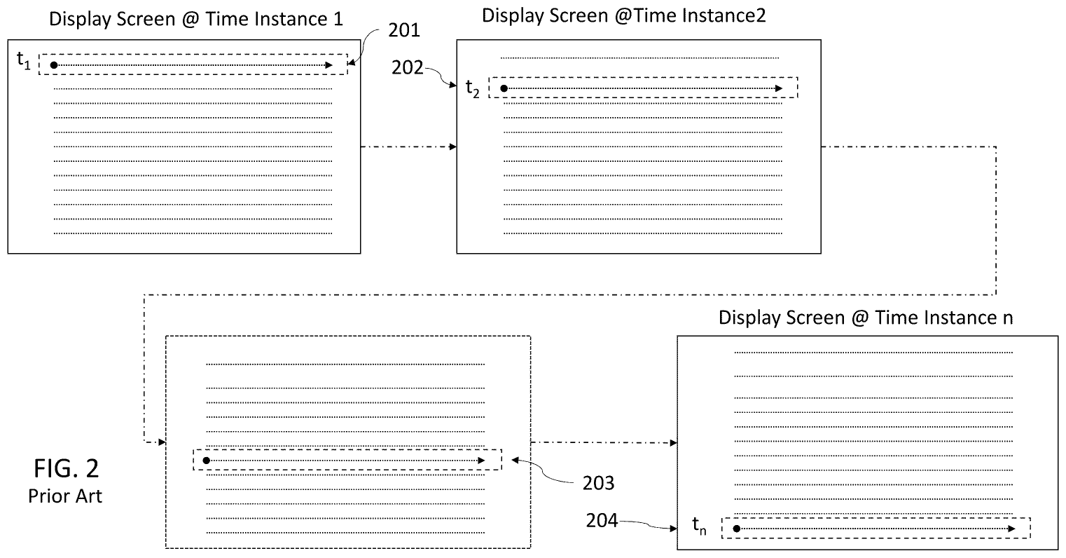

FIG. 2 illustrates that displays like T.OLED progressively refresh each line of pixels on the display. For example, at time instance, t₁, the first line of pixels 201 is refreshed with a new set of colors for the new frame of the image to be displayed. At time instance, t₂, the second line of pixels 202 is refreshed with a new set of colors for the new frame of the image to be displayed. This refresh process repeats line by line until the last line of pixels 204 at time instance tₙ is refreshed, where n is the total number of vertical scan lines in a frame based on the display's resolution specification. For a 720P resolution display, n=720. In slow motion, the refresh process progressing from the top to bottom lines of pixels appears similar to the scan lines of an old cathode ray tube (CRT) TV monitor with lines of phosphorescent pixels glowing by an electron beam to display various color and brightness values at a pixel, then one line of pixels, then all the pixel lines progressively. This means that if one were to use a camera sensor with a global shutter, there is never a time when the whole display screen is turned black, with the exception during the instance between two frames, e.g., 11 us or 11 microseconds, calculated for a display with 120 Hz refresh rate and 720P resolution as 1 second/120 Hz/720 scan lines≈11.5 μs. However, capturing images at a shutter speed faster than several milliseconds is impractical. 11.5 μs is not enough time for a sensor with a global shutter to capture a frame of the image. The prior art teachings are inconsistent with the current state of the art for commercial display products. Short of utilizing a custom-made display that can turn off all pixels at once for multiple milliseconds, it is practical to use the progressive fashion of pixel line refresh on T.OLED displays.

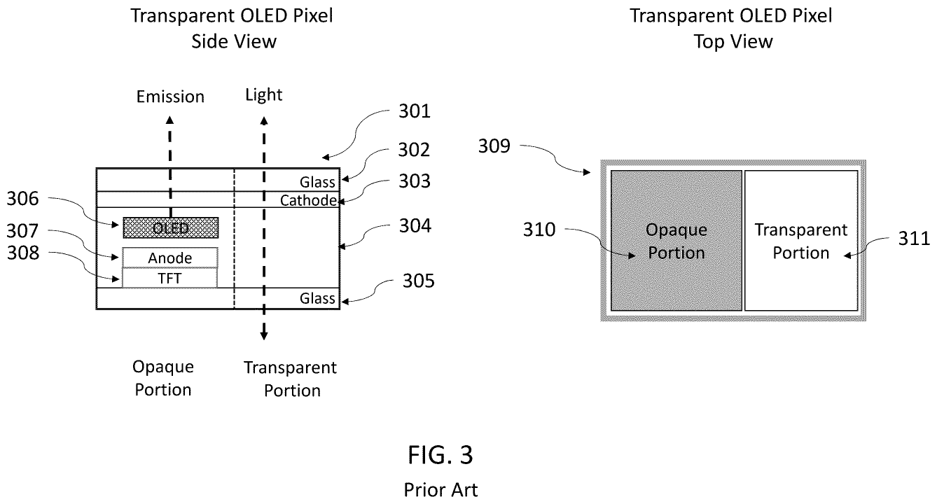

FIG. 3 illustrates a single pixel of a T.OLED display in a top-down view. The whole pixel 301 in the side view comprises two sections, a transparent section 311 and an opaque section 310. The components of the inner workings of a T.OLED display are readily understood by one of ordinary skill in the art and, therefore, not described. To understand the present invention, one of ordinary skill in the art recognizes the pixel stack of OLED 306, anode 307, and TFT 308, which produce the light for the display, also block light from going through the display and are, therefore, considered an opaque optical path. Yet, in the transparent section 311, glass 302, cathode 303, gap 304, and glass 305 are all transparent materials. A T.OLED display is considered transparent because of the transparent section 311 at each pixel. The opaque section 310 remains opaque regardless of the color emitted from the OLED component 306. Even when all the power is cut to the pixel and no light emits from OLED 306, the opaque section 310 remains opaque. A T.OLED display is, therefore, always considered transparent because a portion of each pixel remains transparent.

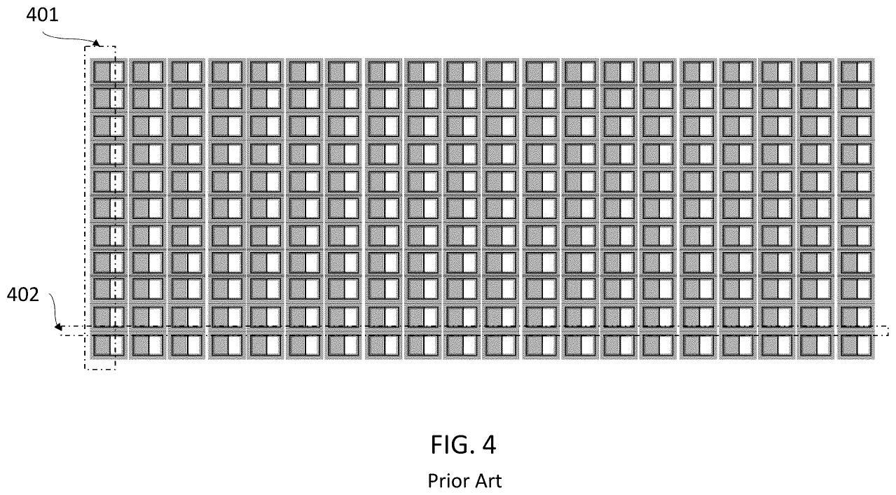

FIG. 4 illustrates the pixel layout in a T.OLED transparent display. In this active matrix formation, the nontransparent opaque section of each pixel is shown in 310 of FIG. 3 and collectively create a layer of a mesh-like structure obstructing and distorting light transmission from the front to the back for the camera disposed behind the display. In particular, for an LG-manufactured T.OLED display, column 401 appears as a heavier vertical pattern and causes more distortion for light than row 402 of gaps between pixels. Such mesh patterns influence the type of distortion correction technique required. A manufacturer can lay out pixels differently than shown, changing distortion patterns caused by the mesh structure.

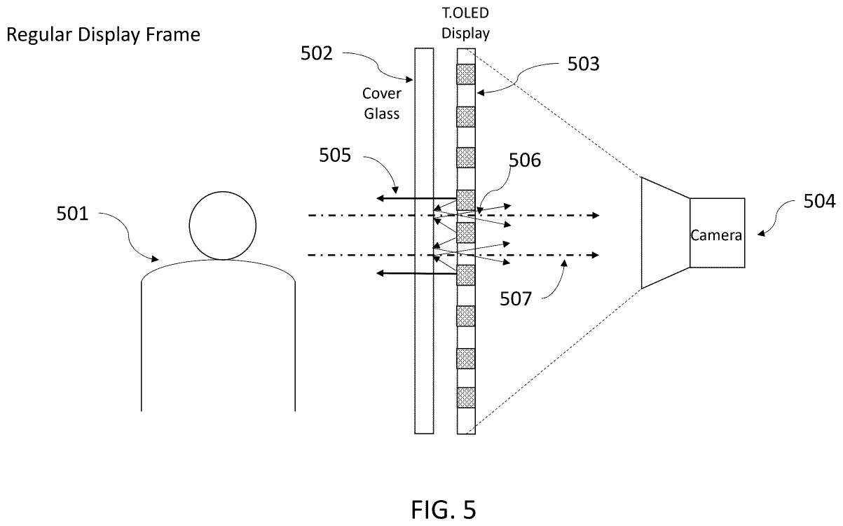

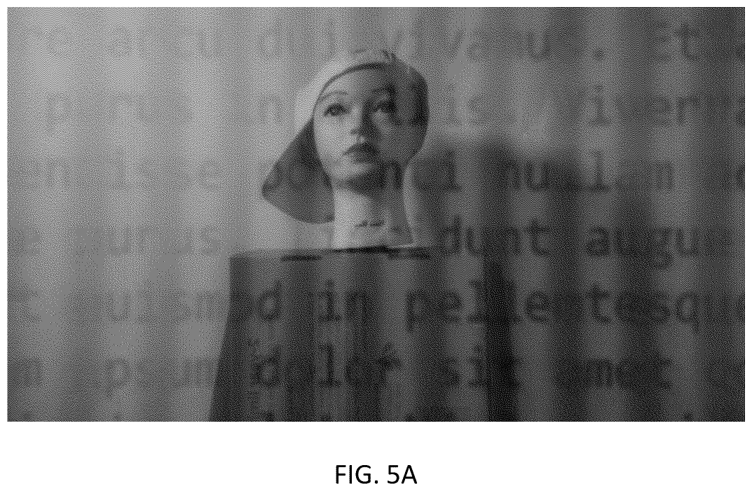

FIG. 5 illustrates how the cover glass for a T.OLED display creates optical interference. The T.OLED display layer 503 has a certain number of pixels depending on its resolution. To protect the T.OLED pixels, a protective cover glass 502 is included. When a pixel emits light 505 transmitting from the pixel to the person 501 in front of the display, the cover glass 502 reflects some of the light 505 backward as light 506 to the camera 504 behind the display through the transparent apertures 311. When these light waves 506 reach the camera's sensor plane, the interaction between these light waves creates a ripple, forming a Moiré pattern. The reflected light waves 506 also create a distorted ghost image captured by the camera 504. The Moiré pattern and distorted ghost image are the most critical distortions to remove. FIG. 5A is a picture of a manikin in front of a T.OLED display captured by a camera behind the display's backside without removing the interference from the reflected and distorted optical pattern or Moiré pattern. As shown in the picture, the ghost image of the digital content (in this instance, text) displayed on the front side of the T.OLED display is present.

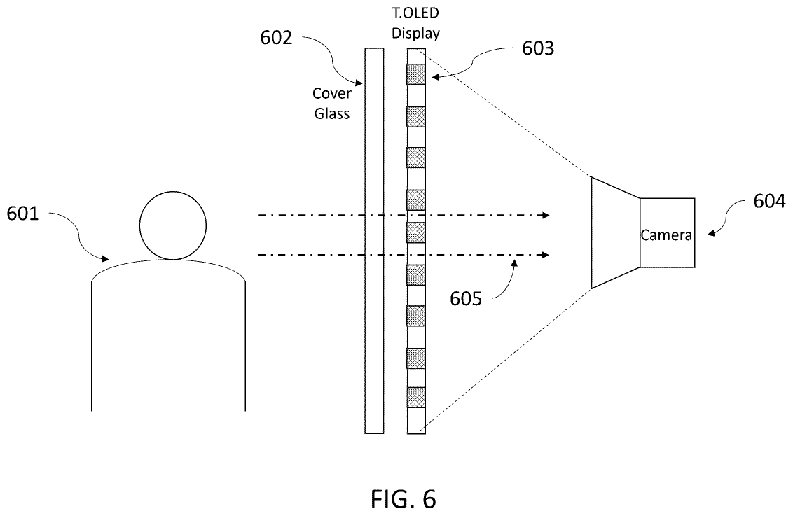

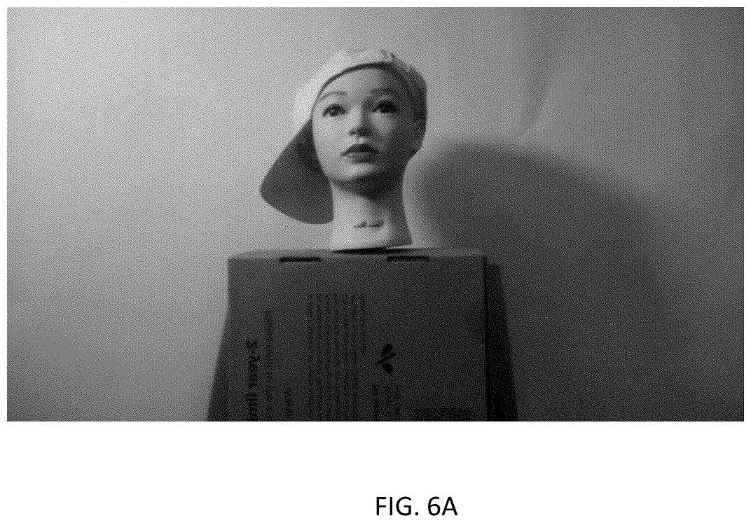

In contrast, FIG. 6 illustrates when T.OLED pixels 603 are not emitting light to the front of the display, the cover glass 602 does not reflect light backward, and therefore, the Moiré pattern interference does not appear in the camera's captured image. Only regular light 605 from the person in front of the display transmits backward to the camera disposed behind the display. FIG. 6A is an image captured by the camera disposed behind the T.OLED display when the display is completely turned off. In this case, none of the T.OLED pixels 603 emitted light to the front, and no light was reflected backward. The picture is free of interference from the Moiré pattern. However, the T.OLED is not as transparent as a clear sheet of glass, and it is apparent that distortion caused by the pixel mesh is still present. The present invention removes all distortion from the picture so that a human can not distinguish between the invention's corrected image and an image captured through a clear sheet of glass.

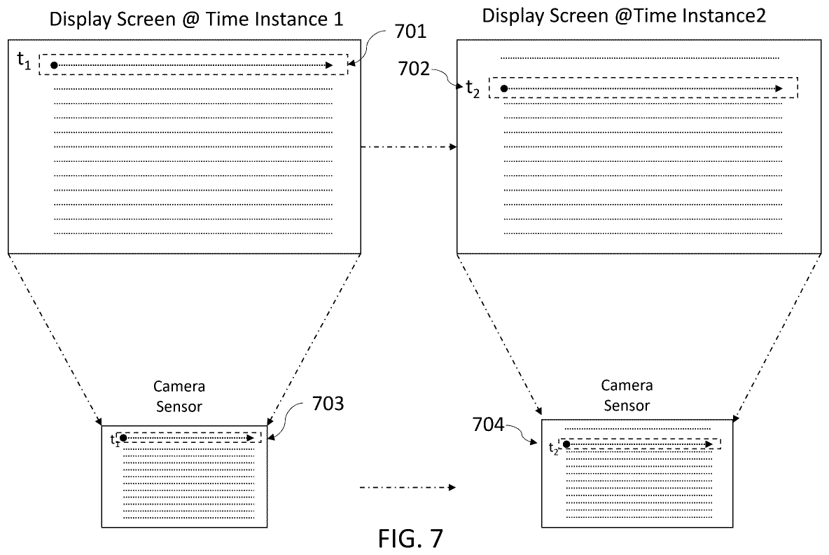

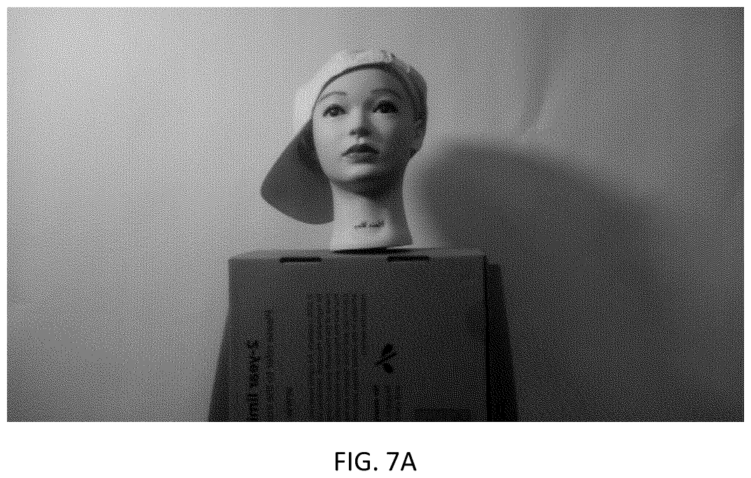

FIG. 7 illustrates a technique to eliminate the Moiré pattern interference according to an embodiment of the invention. Here, the black pixel line refresh is synchronized with the movement of the camera's rolling shutter opening so that the camera sensor only exposes a line of sensor pixels to capture a line of the image of a person in front of the display when the corresponding line of display pixels is turned black. At time instance t₁. display pixel line 701 is refreshed to color black, and in synchronicity, sensor scan line 703 is opened by the rolling shutter control. At this time instance, there is light emitting from the display pixels in line 701, and no light will be reflected backward by the cover glass; the camera sensor captures light 605 transmitting from the front to the back without interference of the Moiré pattern, nor see any reflected ghost image of the digital content on the display.

In this method, the T.OLED display is required to refresh at least at 120 Hz, meaning it can finish refreshing an entire image frame of pixels within 8.33 ms per frame (=1 sec/120 fps), or 11.5 μs per line (=8.33 ms/720). This high refresh rate is necessary to ensure human eyes do not perceive any black pixel lines causing flashing or flickering on the display. The camera sensor must capture and transmit at a speed of 60 frames per second while exposure time (not including data processing, buffering, and transmitting delays) for scanning a full frame of pixel lines must finish within 6 ms to 7 ms. This ensures that when a line of black pixels is present for 11.5 μs, the sensor's rolling shutter finishes scanning or exposing a sensor pixel line within the same period. For a 1080P resolution display and a matching 1080P resolution camera sensor, it is conceivable the camera sensor must scan faster, finishing sensor scanning per line within 7.7 μs. FIG. 7A is a picture of a manikin model in front of a T.OLED display captured by a camera disposed behind the display on the backside. The black pixel lines of the display were refreshed in synchronization with the rolling shutter opening of sensor pixel scan lines, effectively removing any ghost image or Moiré pattern interference.

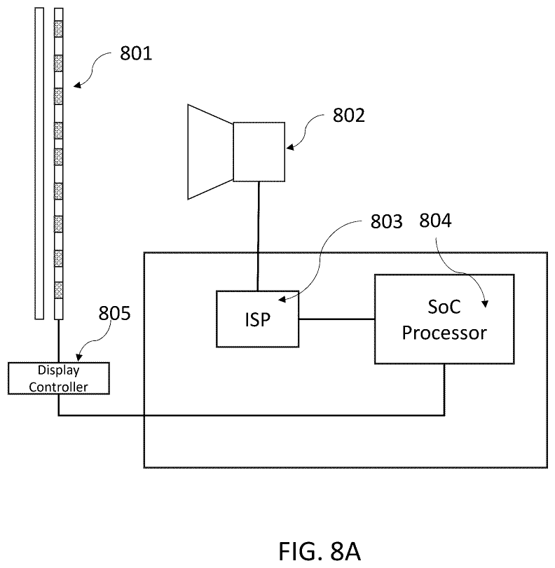

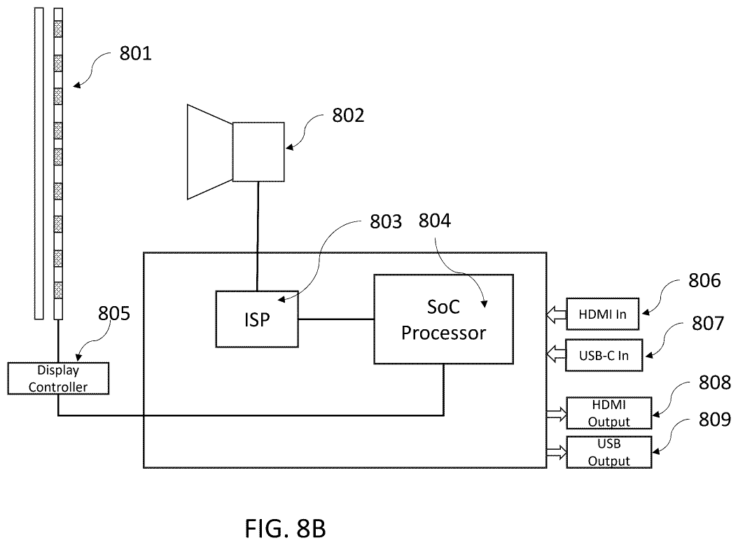

FIG. 8A illustrates a transparent display system according to an embodiment of the invention. The system comprises a camera 802 disposed positioned behind, i.e., rear of, a transparent display 801 along the display's center axis on its back side and a processor 804, which may take the form of a system on a chip (SoC). The center axis is the axis that traverses perpendicularly through the center of the display area. Within the scope of this invention, the camera can also be positioned off the center axis and directed toward the center of the display area in alternative embodiments, preferably with the entire display screen within the camera's field of view. The captured video in such an angular placement can be corrected using optics or digital signal processing. Most displays come with a built-in display controller 805, and most cameras need to work with an image signal processor (ISP) 803, but these components are beyond the scope of the present invention.

FIG. 8B illustrates an alternative embodiment of the transparent display system. In addition to the system shown in FIG. 8A, the system may include any combination of ports such as but not limited to USB3 or USB2 807, an HDMI in port 806, an HDMI out port 808, and a USB OTG output port 809. The addition of input and output connectivity allows for the system to connect with an external content source device or an external host terminal device, enabling the system to be used as a second monitor, a digital teleprompter, a peripheral device like a webcam, or a collaborative communications device with a shared virtual glass board within a video conferencing context.

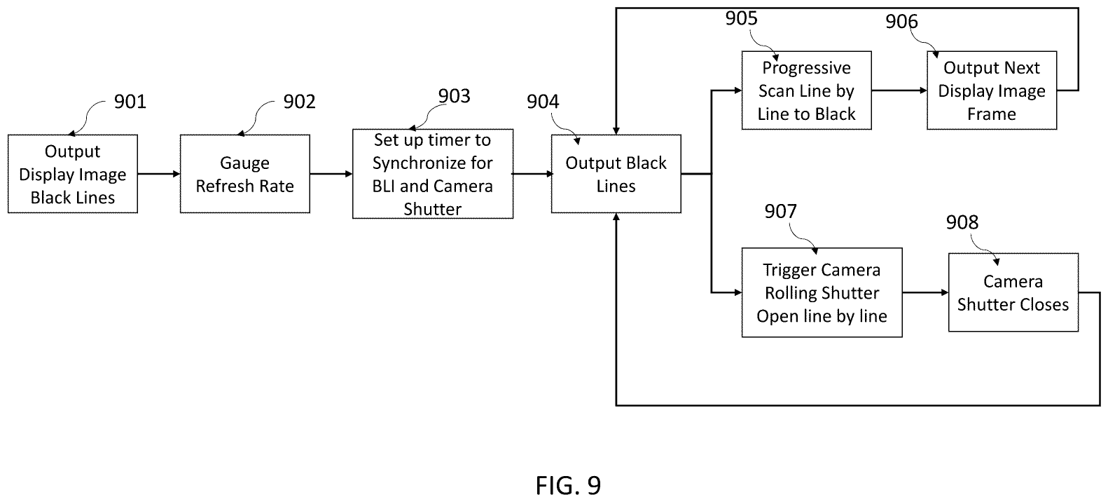

FIG. 9 illustrates a method for black line insertion synchronized with a camera sensor's rolling shutter line-by-line scanning to remove the ghost image and Moiré pattern interference. At step 901, the system's processor outputs a batch of black lines to the display to measure the elapsed time for refreshing a single line of pixels. At step 902, the processor gauges the display's refresh rate by using a photo-sensitive diode sensor or measuring the time to finish a full frame of pixels on the display and/or the beginning and ending times to refresh each pixel line. The timing information is used subsequently to set a timer to synchronize black line insertion (BLI) and camera rolling shutter movement in step 903. The processor outputs BLI in between two display frames in step 904. The display initiates a line-by-line refresh of pixels to black in step 905, and when the refresh is finished for a full screen of pixels, the processor outputs a frame of the display image in step 906. When step 906 is complete, the process loops back to step 904. Simultaneous to step 905, the processor sends a trigger signal in step 907 based on the timer to the camera shutter control interface, such as a GPIO port or I2C port to open the rolling shutter to scan line by line matched in space and time to capture images when the black line by black line is refreshed on the display. When all the pixel lines are refreshed and the camera's shutter has finished scanning all sensor scan lines, the shutter closes in step 908, then repeats by waiting for step 904 to start again.

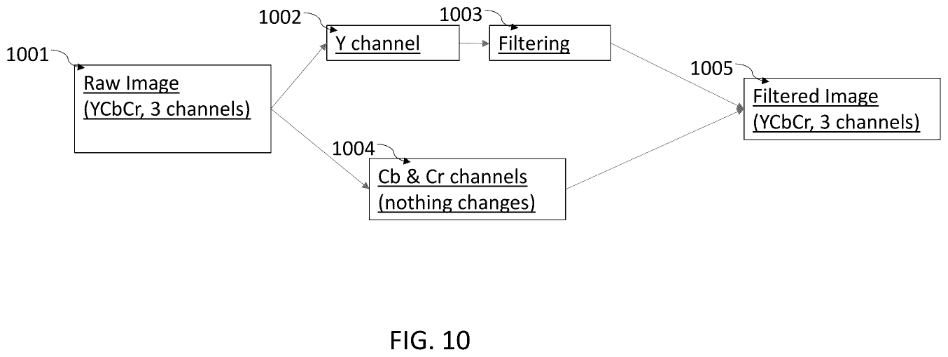

FIG. 10 illustrates a method for raw image encoding, Y channel filtering, and image correction to produce the final filtered image according to an embodiment of the invention. This method eliminates the distortion created by the pixel mesh structure. At step 1001, the raw image data captured by the behind-display camera is encoded into the YCbCr color space. Mesh distortion largely influences the Y channel, which encodes light intensity or brightness information. The Y channel is isolated in step 1002, and spatial filtering is performed on the Y channel in step 1003. The Cb and Cr channels are left unchanged at 1004. After filtering the Y channel, the filtered Y channel data is recombined with the Cb and Cr channels to create a filtered image at 1005. By filtering only the Y channel, without performing any filtering on the other two channels, Cb and Cr, the present invention effectively eliminates the distortion caused by the mesh pattern with a savings factor of three in computation.

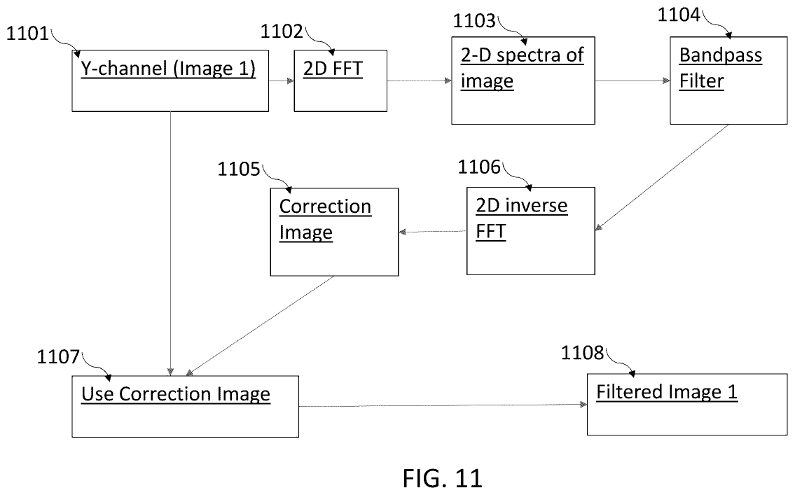

FIG. 11 illustrates a method for creating the Y channel filter, expanding the inner workings of step 1003 above. A two-dimensional fast Fourier transformation (2D FFT) is performed at step 1102 against the Y channel image data 1101. As a result, the FFT transformation produces 2-D spectra of the Y channel image at step 1103. The signature profile frequency distribution pattern in the 2-D spectra is identified in step 1103. Subsequently, a bandpass filter isolating the frequency distribution profile is created in step 1104. After eliminating every other frequency outside of the bandpass filter, the filtered spectra undergo a 2D inverse FFT in 1106, which transforms the frequency profile back to the spatial domain of the Y channel. The resulting spatial domain image from the 2D inverse FFT of step 1106 is the correction image 1105, capturing the spatial domain profile of the mesh structure. Using the correction image of 1105 as the offset against the Y channel raw image at step 1107 results in the filtered image of step 1108, eliminating the distortion of the mesh.

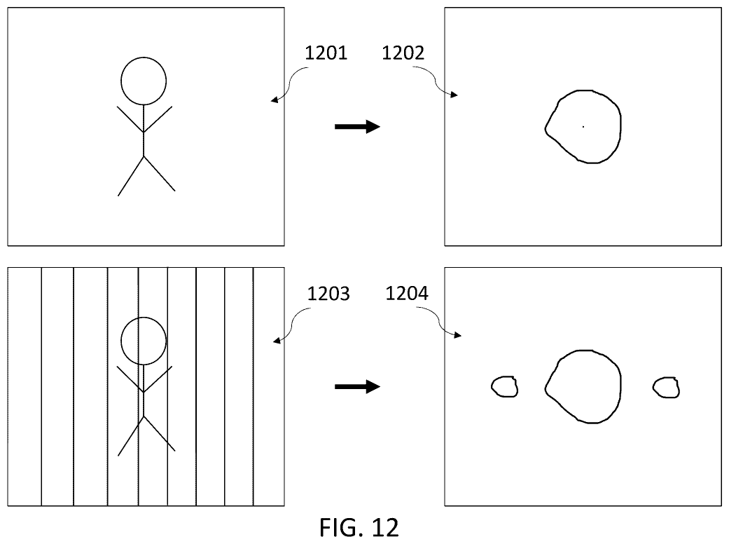

FIG. 12 illustrates when a person is in front of a clear sheet of glass in 1201. The captured image transformed with a 2D FFT results in a spectra profile in the frequency domain, specifically near the center (0,0) point of the spectra, similar to picture 1202. When a person is in front of a display with a vertical pattern mesh structure, the resulting 2D FFT transformation of image 1203 appears similar to picture 1204, showing two distinct notches representing the mesh distortion in its frequency distribution profile.

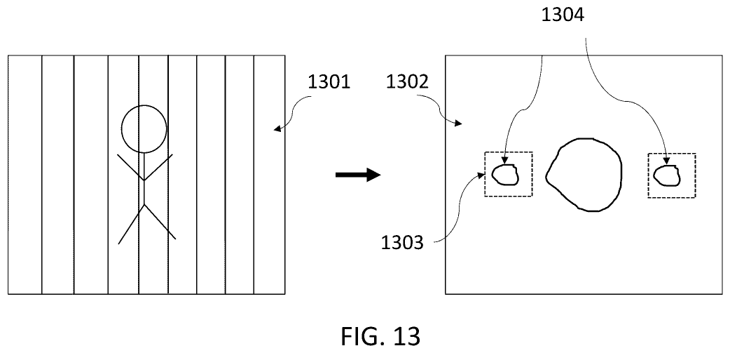

FIG. 13 illustrates a person in front of a display 1301. When a 2D FFT is performed against that spatial image, a spectra image 1302 is created in the frequency domain. The bandpass filter noted above is defined by the dashed line boundary boxes 1303. Boxes 1303 are determined by the area occupied by the two side lobes 1304, representing the encoding of the mesh distortion profile in the 2D spectra.

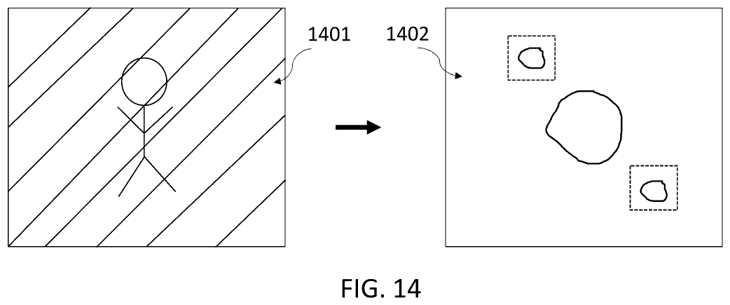

FIG. 14 illustrates when a mesh is oriented diagonally, i.e., at 45° from horizontal, in display 1401. The spectra image in the frequency domain after a 2D FFT transformation is picture 1402. Thus, the region of the mesh spectra profile rotates in direct correlation to the spatial image rotation of the mesh. This discovery helps address different spatial domain distortion patterns based on different mesh designs in a display screen.

In an alternative embodiment of the invention, the 2D FFT transformation is substituted with a direct cosine transformation (DCT) or other transformation capable of achieving 2-D spectra in the frequency domain.

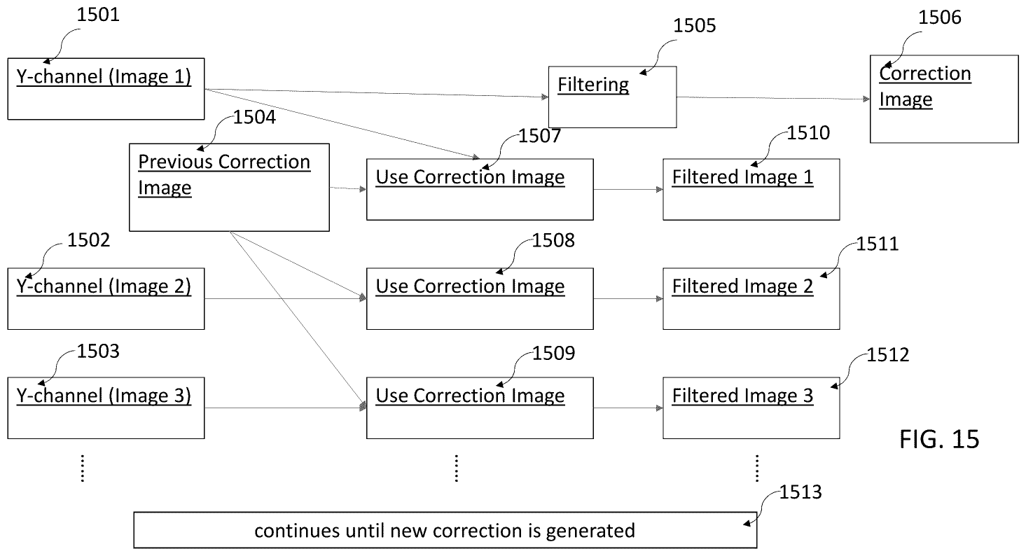

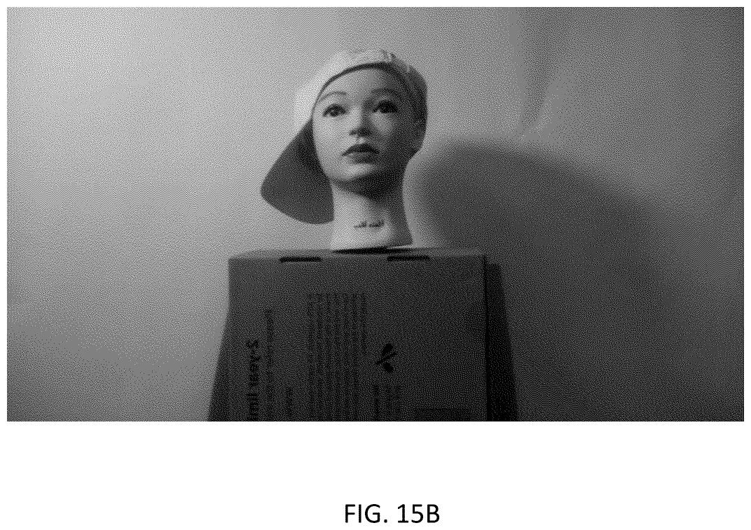

FIG. 15 illustrates applying and reusing a single correction image to a series of captured raw images to avoid overly heavy computation for every frame and ensure a high frame rate display of camera preview images. After filtering 1505 the Y-channel raw image 1501, following the process described above, a correction image 1506 is created. Once this correction image is obtained, it replaces any previously used correction image 1504. The correction image is used as an offset against Y-channel image 1 of 1501 and achieves a filtered image 1 of 1510. Subsequently, instead of filtering and calculating a new correction image for every new frame of a captured image, the inventors discovered that the correction image could be reused due to the fixed nature of the mesh structure and pattern. For a new Y-channel image 2 of 1502, the method applies the same correction image of 1506 as offset at 1508 and achieves filtered image 2 at 1511. Reuse of the correction image of 1506 continues for Y-channel image 3 of 1503 to achieve filtered image 3 of 1512, and so on until a new correction image is generated at 1513. Reusing a single correction image for a series of image frames reduces computational resources by a dozen times and ensures a high frame rate display of filtered images.

FIG. 15B is a picture of a filtered image free of Moiré Pattern interference and mesh distortion. It reaches a clarity level nearly indistinguishable from a picture captured behind a clear sheet of glass, particularly human perception in everyday video conferencing contexts, where image resolution or fine detail is not the primary concern.

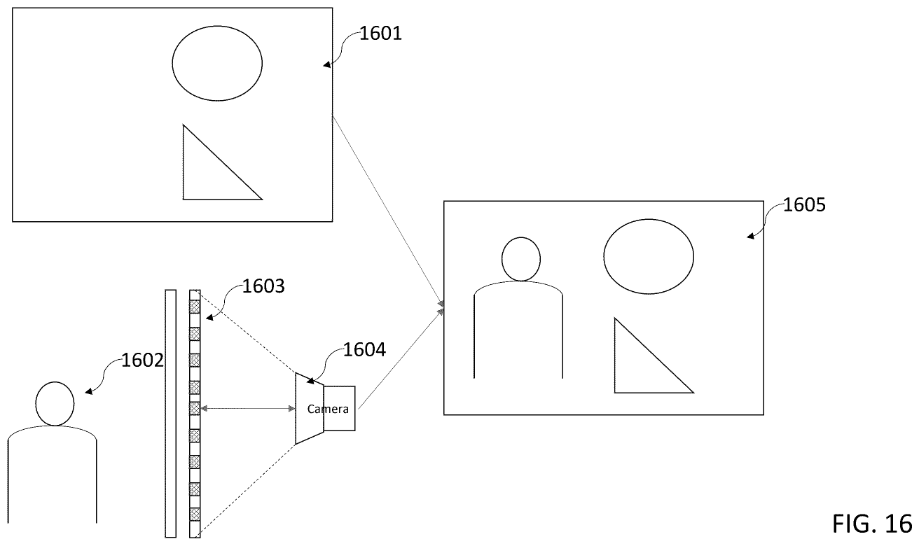

FIG. 16 illustrates a method for constructing a person-embedded view image by combining the camera view of a person in front of the display with digital content shown on the display. In most video applications, digital content 1601 on a computer display is separate from the user's camera view. This is especially the case in video conferencing application windows. Once a screen share is displayed in a video call, the person's view captured by a camera is reduced to a thumbnail view and positioned at a corner of the screen. At the same time, the digital content takes up the majority of the display screen area. In such a prior art environment, the camera view image makes the person appear as if they are looking away instead of at the audience, while in reality, the person is actually looking at the digital content to present the digital content to the audience. The present invention system captures a person's image 1602 from behind a display 1603 with a centered behind-the-display camera 1604 where the person's image appears naturally. The camera then flips the left-right orientation of the person's image to create a mirrored image of the person. The digital content can be made transparent by setting the background color to have a 100% transparent alpha channel, leaving the foreground objects with contrasting and bright colors. The transparent digital content is layered as a superimposing layer on top of the left-right flipped camera view image to achieve a combined image with the person and the digital content embedded together. In this person-embedded view image, the camera correctly captures the person's gaze, pointing, writing, gestures, and expressions. When superimposed with the digital content, the audience sees exactly where the person is gazing, where he is pointing, where and what the person is writing. In the setting of a Zoom or Teams video conference call, the presenter can show the combined view, embedding the person view with the digital content view as a regular camera stream instead of a screen share. This results in a much more natural-looking video, as if the camera is behind a clear sheet of virtual glass, capturing the person's image and the ink the person is writing on the glass.

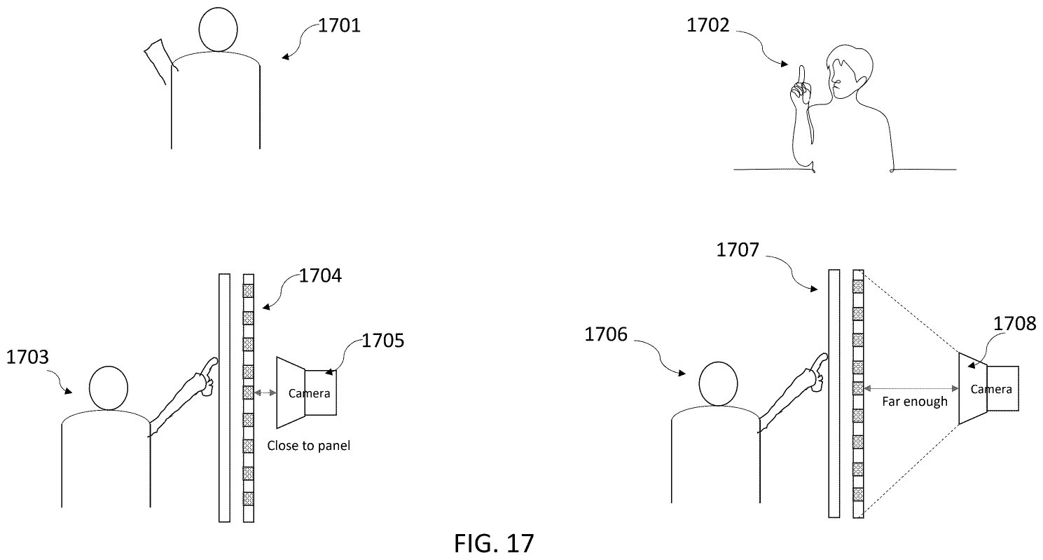

FIG. 17 illustrates the effect of varying the depth of the centered behind the display camera from the back side of the display. As shown on the left side of this figure, camera 1705 is located a short distance from the backside of the display 1704, such as 5-6 centimeters. It will capture most of the person 1703 in front of the display before the person starts to touch the surface to write on it. However, once the person begins writing by touching the display surface, if it's interactive, the person's hand or fingertip may go beyond the FOV of the camera and appear as if the hand is clipped off. At a different distance like that shown on the right, using camera 1708, when the camera is far enough to include the entire backside of the display inside of its FOV, the person's finger, hand, and whole arm are all visible in a person embedded image of both the person and the digital content. In situations such as diagramming out a concept or a design, it could be highly desirable to see the fingertip of the presenter along with a centered view of the presenter, who appears natural in the image. In other situations, capturing the realistic view of a person in a video call by having the camera centered behind the display will suffice.

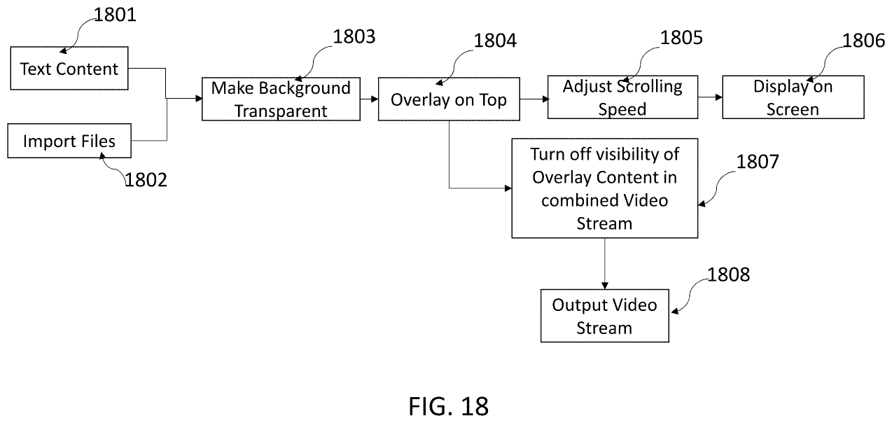

FIG. 18 illustrates a method for applying the system of the present invention as a digital teleprompter. When script content is acquired in steps 1801 or 1802, the content is made background transparent at step 1803. The digital script content is then placed as an overlay layer on top of a person-embedded image with both the person in front of the display and other digital content presented on the display at step 1804. The script content can automatically scroll to match the person's audio narrative speed at step 1805. The script content is visible in step 1806 and can be used as a confidence monitor. For any video recording or for presenting in a video conference call setting, the overlay content is set to be invisible to the recorded or transmitted video stream at 1807 and 1808.

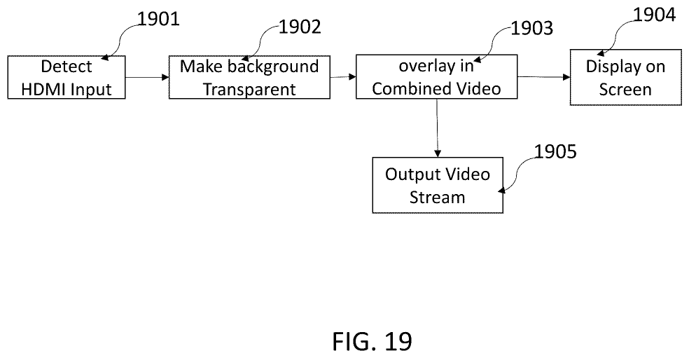

FIG. 19 illustrates a method where the system of the present invention is used as a second monitor for an external computer. The processor of the present invention detects external input sources through an HDMI input port at step 1901. Due to the nature of the HDMI connection industry standard, the external computer would automatically recognize the system of the present invention as a connected monitor. The external computer will then output an HDMI video stream. The system of the present invention accepts the HDMI video stream input and makes the video stream background transparent, leaving the foreground in high contrast and bright colors at step 1902. The input HDMI video stream is then combined with or overlaid at step 1903 on top of local digital content on the system's display combined with the person-embedded view image already combining a person's camera view with local digital content.

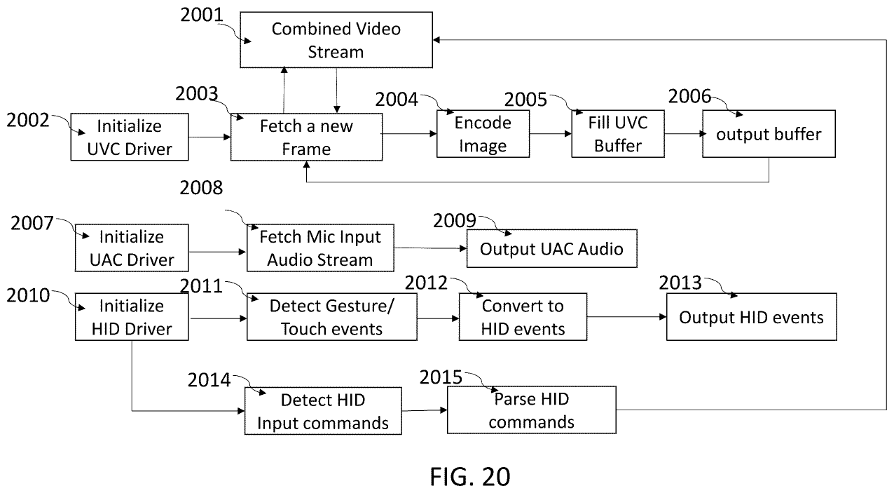

FIG. 20 illustrates a method where the system of the present invention functions as a simple webcam for an external computer. An external computer can bring in the entire person-embedded view image of the system as a webcam and let the webcam UVC stream appear in a video conference call as if the system is a simple webcam. The natural appearance of the user and the combined digital content improves the video conference significantly. To accomplish this, the system's processor initializes a UVC driver 2002, a UAC driver 2007, and a HID driver 2010. The processor fetches a new image from the person-embedded image stream 2001 just constructed through previous methods described above, at 2003. The method encodes the fetched image using a CODEC at 2004, fills a UVC buffer at 2005, and outputs with encoded UVC data format through an output buffer in 2006 via a USB OTG port such as 809 of FIG. 8B. For audio stream output, the processor fetches a microphone input audio stream at step 2008, then encodes the audio using an audio CODEC, and outputs UAC formatted audio stream via a USB OTG port such as 809. For HID event data, the processor detects events from gesture recognized, touch events, keyboard, trackpad, or mouse events in step 2011, then encodes into USB HID event data format at step 2013, and outputs through a USB OTG output port like 809.

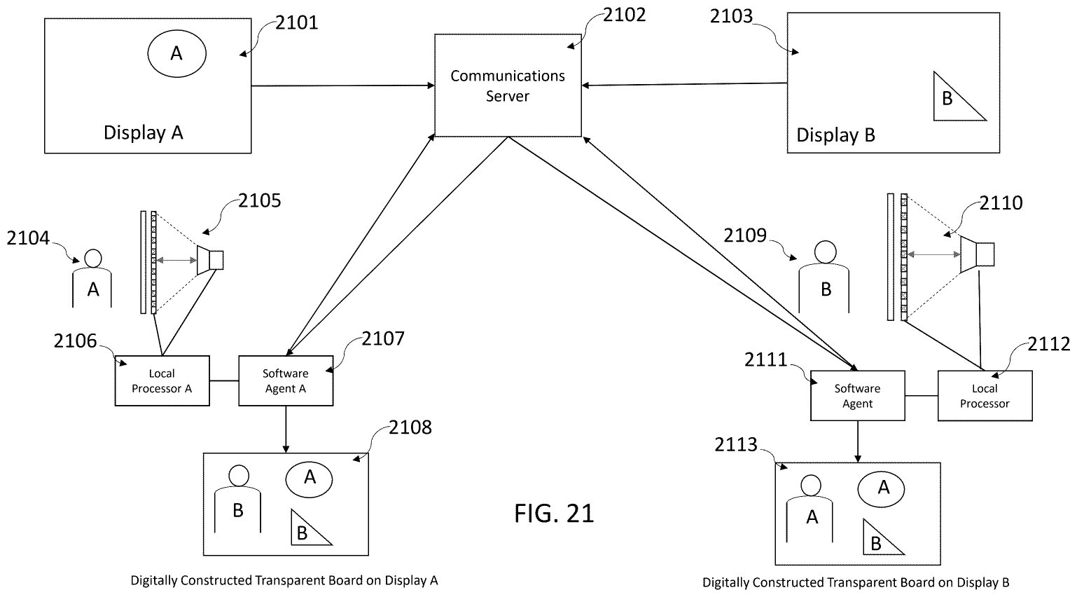

FIG. 21 illustrates a collaborative video communication system that incorporates a cloud-based communications server to facilitate the system in FIG. 16 to work with the same remote system to combine the person-embedded image view with a shared digital virtual glass board. In such a system, both parties of the video conference communication see the other party's person-embedded view images while sharing a transparent digital “glass” board so that each party can write or add digital content to the commonly shared board. Each party can see in the person-embedded view exactly where the other party is pointing or where or what the other party is writing.

Using the system of FIG. 16, system A, a circle is displayed on display A of system A to form a digital content view A at 2101. Also, in system A, person A is in front of display A, with a behind display center camera at 2105 producing a person A embedded digital view A. Furthermore, a local processor A controls the processes in system A, working with a software agent A at 2107. In a remote second system, using the same system of FIG. 16, system B, a triangle is displayed on display B of system B to form a digital content view B 2103. Also, in system B, person B 2109 is in front of display B 2110, with a camera behind the display to produce person B embedded digital view B. Furthermore, a local processor B 2112 controls the processes in system B, working with a software agent B, at 2111. The effect of this communications system is that person A 2104 will view the digital view A+B with person B embedded as in 2108, while person B 2109's view is a constructed digital view A+B with person A embedded as in 2113.

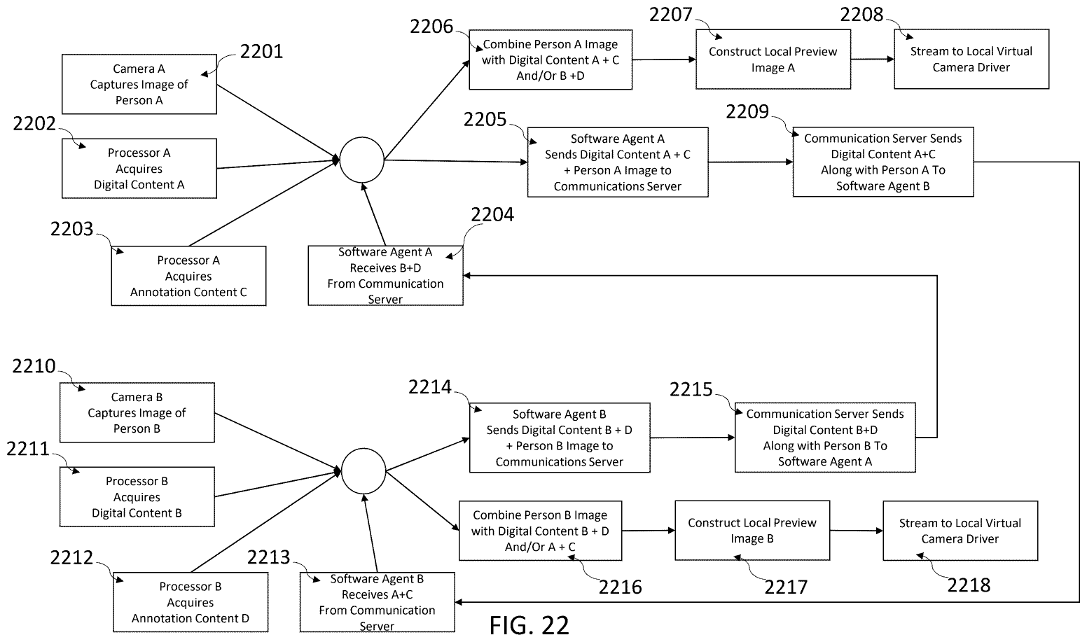

FIG. 22 illustrates the method for the system in FIG. 21, enabling two parties, person A and person B, to collaborate via a communications server with person-embedded view images of each other in a constructed digital image sharing a digital virtual glass board with each other's person view embedded. In system A, camera A captures person A image at 2201. Processor A acquires digital content A image at 2202, accepts new annotation C at 2203, and receives through software agent A from the communications server of digital content B+D at 2204. Processor A combines person A image with digital content A+C+B+D image into a person A embedded digital view A at 2206. Processor A stream constructs person A embedded digital view A to local virtual camera preview driver at 2208. Processor A sends person A image, digital content A+C+B+D, and person A embedded digital view A to the communications server at 2209. The communications server sends those three distinctive image streams to software agent B at 2213. System B performs the reciprocal actions of system A, and processor B sends its respective three image streams to the communications server, which sends the system B side streams to software agent A at 2204. Both sides see the same virtual glass board with all digital content A+B+C+D. Person A will see a person B embedded digital image with A+B+C+D and person B will see a person A embedded digital image with content A+B+C+D.

In further embodiments of the invention, the T.OLED is replaced with a video projector and a transparent projection screen of clear material such as but not limited to glass or acrylic with a higher degree of transparency, i.e., at a minimum of 25% transparency but preferably more than 40% and as high as 90% to 92%. In a preferred embodiment, the video projector is a short throw projector or ultrashort throw projector that projects a video image of digital media content onto the transparent projection screen at a distance that facilitates a projection angle of less than 45 degrees relative to horizontal. The identification and implementation of the short throw projector or ultra short throw (UST) projector are apparent to one of ordinary skill in the art. A behind-display camera captures a video image through the transparent projection screen of the user located on the front side of the screen. Such a passive transparent display screen configuration improves user image capture because the distortion associated with a T.OLED is significantly reduced if not eliminated.

To optimize the brightness of the projected video image (as viewed by the user) while preventing the behind-display camera from capturing that same projected video image transmitted through the screen, a series of optical layers in the form of films and/or coatings are included in the optical path between the projector and the camera. The series of optical layers may comprise a first linear polarizer, a partially reflective layer or dispersion layer, and a second linear polarizer. The first and second linear polarizers are orthogonal to one another, i.e., their axes are oriented 90 degrees to one another to block the projected image from being received by the camera. In a front projection arrangement, the partially reflective layer is designed to reflect a bright projected image to the user while permitting ambient light on the user's side to transmit to the camera. In a rear projection arrangement, the dispersion layer is designed to transmit a bright projected image to the user while permitting ambient light on the user's side to transmit through to the camera. In contrast to T.OLED and Transparent MicroLED display screens, the transparent projection screen can only reflect or scatter light but can not actively emit light by itself. The use of a projector is therefore necessary. The partially reflective layer can be a multilayer dielectric coating, a single layer made of an optical material with a substantially different refractive index, or a metal or alloy coating. The dispersion layer may comprise metal particles such as silver or crystals to disperse light. The inventors achieved a 95%-99% clear camera image (relative to capturing an image through a clear sheet of glass) when the transparent display screen with the dispersion layer had only a 60% degree of transparency.

When the projector projects light onto the front of the screen, the resulting image is never as bright as viewing a light emitting active display. To display a bright and clear picture on the screen, the injection angle for incoming light from the projector should be as straight as possible. The image is severely dimmed when the light is injected at more than 70 degrees from the horizontal. Such dimming would make the resulting display undesirable and infeasible for widespread or commercial use.

In a preferred embodiment, the UST projector is desirable for compactness and aesthetics. UST projectors will likely inject light at greater than a 70-degree angle. A regular or short-throw projector will produce much brighter images with even brightness across the entire surface. However, they require a significant distance between the projector lens and the display surface. The form factor may not fit on a user's desk when attempting to create a video conferencing device using the passive display screen and a short-throw projector.

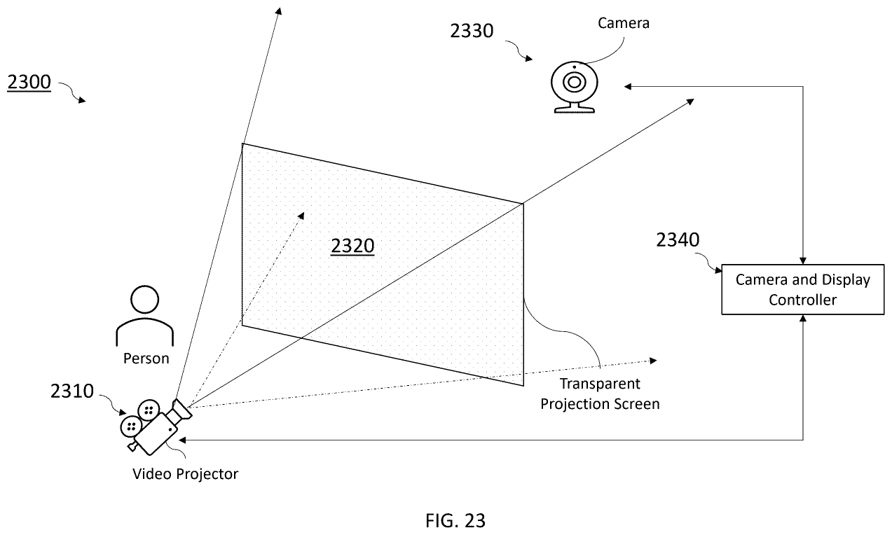

FIG. 23 illustrates a front projection transparent display system 2300 according to an embodiment of the invention. In this arrangement, a projector 2310 is disposed on the front or same side of the user (“person”). A transparent projection screen 2320 is located in between the projector 2310 and a behind-display camera 2330. As discussed above, the transparent projection screen includes a partially reflective layer on its front side, which faces the projector 2310 and the user. In this core configuration, a portion of the video image projected onto screen 2320 by the projector 2310 will transmit through the screen 2320, if untreated, and reach the lens of the behind-display camera 2330. For video conferencing or video recording purposes, it is more desirable for the camera 2330 not to “see” any projected content. Instead, the camera 2330 is expected to see through the screen and only capture an image of the user and the user's environment. In real-time or near real-time, the video stream captured by the camera 2330 with the user is combined to embed the person's image with the projected digital content to form a presenter-embedded image. Such a front projection arrangement provides the user with the brightest image as the nature of the transparent screen is brighter on the front side of screen 2320, where the projector 2310 is casting light.

Camera and display controller 2340 is an optional processor that can implement the black line insertion and rolling shutter processes described above to remove distortion and interference as described above. However, in projector embodiments, the controller 2340 controls the projector 2310 rather than a T.OLED. In an alternative embodiment of the invention, the polarized layers are not included, and controller 2340 performs black line insertion as described above. For example, the controller 2340 inserts black lines within an interval of 6 ms to 14 ms or at 70 Hz to 120 hz to eliminate bleed-through light captured by the camera.

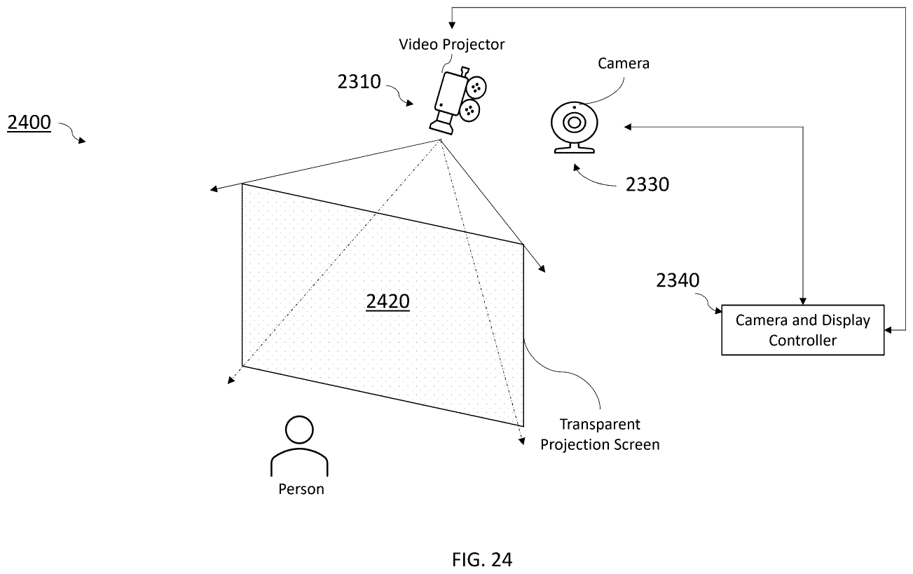

FIG. 24 illustrates a rear projection transparent display system 2400 according to an embodiment of the invention. In this arrangement, the projector 2310 is disposed on the rear or back side of a transparent screen 2420 and on the same side as the behind-display camera 2330. The “rear” surface of a transparent screen 2320 may optionally include a dispersion layer facing the projector 2310 and the camera 2330. In this configuration, the projected light showing digital media content “bleeds” through screen 2320, if untreated further, and typically illuminates and projects the same digital content in larger size onto the viewer's body, which is then captured by the camera 2330 back through the screen. The inventors consider preventing the camera 2330 from “seeing” the projected content desirable. Therefore, camera 2330 is called a “see-through” camera and only captures only the user's image and objects in the user's surrounding environment within view. In real-time or near real-time, this video stream with the user can be combined to embed the person's image with the digital content in a separate software application to form a presenter-embedded image. Such a rear projection arrangement provides the camera with the brightest image as the projector 2310 is casting light on the same side of the screen 2320.

Whether a front or rear projection arrangement, it is desirable for the camera 2330 to “see through” the screen 2320 without imaging any projected digital content from the projector 2310. To accomplish this goal, a pair of orthogonal linear polarizers are introduced into the optical path between the video projector 2310 and the camera 2330, as described below.

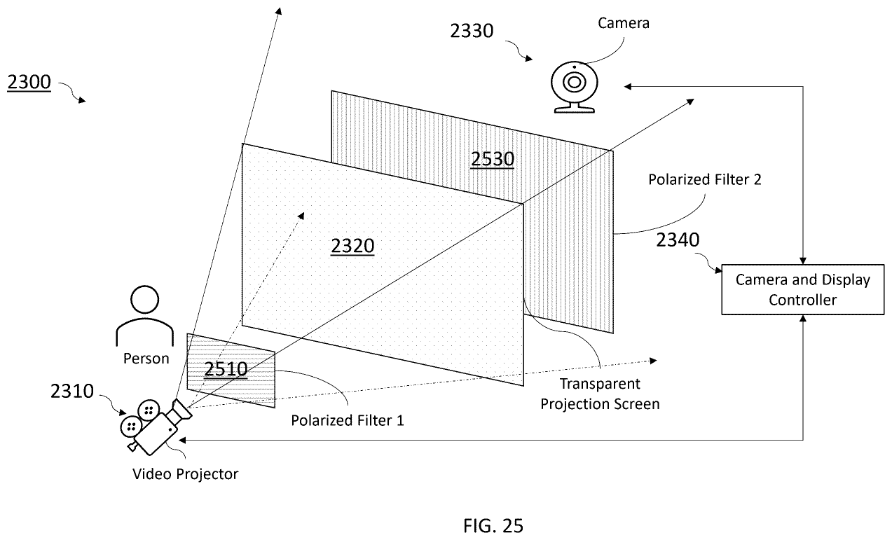

FIG. 25 illustrates the front projection transparent display system 2300 according to an embodiment of the invention. Here, a first polarized filter 2510 is placed in front of or coated on a lens of the projector 2310, and a second polarized filter 2530 is placed immediately behind the transparent projection screen 2320 with a polarization that is orthogonal to the polarization of the first polarized filter 2510.

For example, the light projected out of the projector 2310 lens is filtered by the first polarized filter 2510 with a horizontal polarization, which removes vertical polarization components. When this filtered light reaches the projection screen 2320 surface, digital images are visible to the viewer at about half the original image brightness. However, it will be eliminated once the remaining 50% of light passes through to the second polarized filter 2530 with a vertical polarization. Yet, because the first polarized filter 2510 is not in the optical path of the ambient light of the user and the user's surroundings, it is transmitted through the second polarized filter 2530 to the camera 2330. Because polarization is never 100% horizontal or vertical or the two polarizers 2510 and 2530 can be oriented exactly perpendicular, a tiny amount of projected light always leaks through to the camera 2330. A 1% or 2% leakage is quite common but remains acceptable as it is not perceptible to the human eye in the captured image. When placed adjacent to the rear surface of the second polarized filter 2530 if a film, or if the second polarized filter 2530 is coated onto its lens, the camera 2330 can “see-through” the rear of the transparent display screen 2320 to the front area with the user. Again, the camera 2330 captures only the user's image and surroundings as if there was no projection screen 2320 displaying projected digital content sitting in between. Such a result is beneficial for video conferencing and capturing presentations with the user shown facing the camera 2330.

The use of polarized filters reduces, if not eliminates, the need for the black line insertion and rolling shutter processes described above. If implemented, that process only requires lightweight calculations for simple digital filtering because the distortion is not as strong as with a T.OLED. There is no active LED matrix in the transparent projection screen to account for. Such reduced computation workload is beneficial because dedicated embedded processing, which is cost-prohibitive in many cases, is unnecessary. Yet, implementing polarized filters sacrifices projected image brightness by as much as 50%. Accordingly, the brightness of the projector 2310 must be at least 1500 lumens, preferably above 3,000 lumens, for optimal perception of the projected image by the user. Projectors with even higher brightness may be undesirable for video conferencing because they are generally bulky, likely to get hot, and require noisy fans to cool.

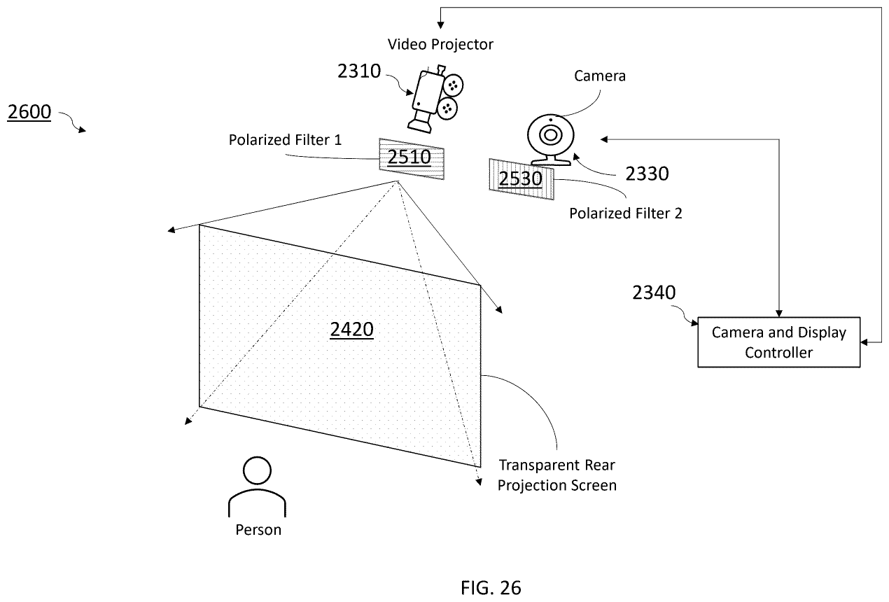

FIG. 26 illustrates the rear projection transparent display system 2400 according to an embodiment of the invention. Here, the first polarized filter 2510 is placed in front of or coated on a lens of the projector 2310, and a second polarized filter 2530 is placed in front of or coated on a lens of the camera 2330. Yet, the first polarized filter 2510, and the second polarized filter 2530 are located on the rear side of the transparent projection screen 2420. The user sees the projected image on the transparent projection screen 2420, but the camera 2330 does not. The camera 2330 sees only the user. The transparent display screen 2420 comprises a dispersion layer in the form of a film or coating on its rear surface. The dispersion layer disperses light from the projector 2530. The scattered light is transmitted to the user through the transparent display screen 2420.

Brightness degradation caused by the acute angle of the light injection by the projector 2310 is significantly worsened away from the center of the display screen 2420 and near its outer frame or periphery. This is likely caused by the increase in injection angle when light reaches these outer areas. For example, at a 70-degree injection angle, light reaches the outer frame of the top edge area of a 16:9 display at an angle of 86 degrees. In this case, light dispersion by metal or crystal particles in the dispersion layer travels away from the user's front view angle and gets deflected in various tangential directions. As a result, the projected image appears brighter near the center of the display screen 2420 and noticeably dimmer toward the outer perimeter. Such uneven display brightness is unacceptable for practical use.

The inventors have discovered that a dispersion layer comprising metal particles sputtered onto a film disperses sufficient light to the user when particle density is high enough. The more acute the light injection angle, the higher the density of particles required. However, higher density comes at the price of losing transparency. Transparency is only possible when particles occupy a relatively small percentage of the surface area but are evenly spread out. Intuitively, higher particle deposition density leads to a higher percentage of light dispersing but is less transparent for ambient light to travel through. In an extreme case where metal particles cover the entire surface at 100%, the display is at the maximum brightness while transparency is nearly 0%. The inverse relationship between dispersion brightness and transparency can be exploited as follows.

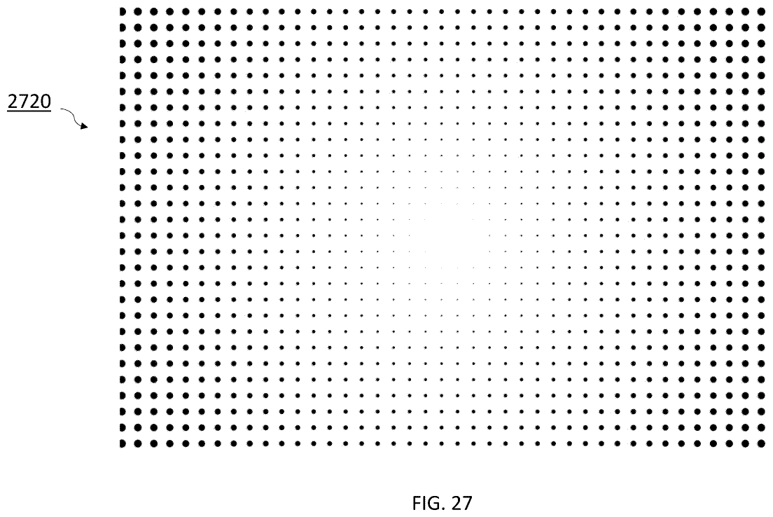

In an embodiment of this invention, the density of particles in the dispersion layer varies. For example, as shown in the dispersion layer 2720 of FIG. 27, the density of metal particles (illustrated by solid circles) increases linearly or geometrically relative to the distance from the center of the display screen 2420 while directing the camera 2330 toward its center. In such a configuration, brightness degradation caused by higher injection angle acuteness is compensated by the higher density of light-dispersing particles deposited at the outer region. This makes it possible for the displayed image to appear evenly bright in the outer and center areas. In this construct, transparency is the highest at the center and lowest at the outermost perimeter. Particle density is the lowest at the center and highest at the outermost perimeter. Such an inverse relationship between density and transparency of the display material ensures even brightness across the entire surface, with the center being highly transparent and the edge regions with significantly lower transparency but high display brightness.

Referring back to FIG. 26, the camera 2330 is behind the display screen 2420 on the rear side. Its function is to capture a regular portrait video stream for the user in front. Again, the desire is not to let the camera 2330 “see” anything that is displayed by the projector 2310 on screen 2420, meaning the user sees projected content with the maximum brightness and clarity, while the camera 2330 sees the viewer clearly as if it is seeing through a sheet of completely clear glass. With the camera 2330 disposed in the center region on the rear side, almost immediately next to the display screen 2420 itself, it enjoys the highest level of transparency, free from suffering low transparency near the outer region. Such a rear configuration allows a UST projector to enable a compact and aesthetically pleasing industrial design with even and bright projected content on a passive display screen while achieving a clear camera image capturing as if it is seeing through a completely clear glass.

In yet another embodiment, the camera and display controller implement machine vision processing to identify a person and subsequently move the camera 2330 with x-axis and y-axis movements to always directly face the person even when the person moves around within the frame.

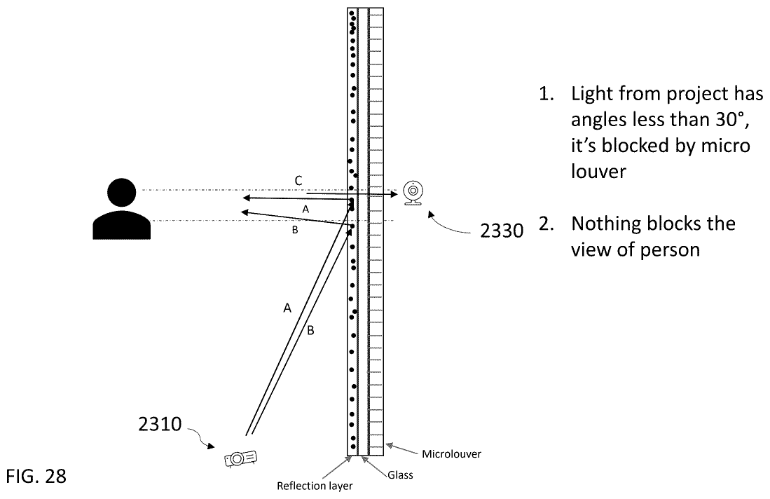

FIG. 28 illustrates a front projection transparent display system according to another embodiment of the invention. Here, the polarized filters are eliminated by using one or modifying the display to control or block light transmission through the display, particularly to prevent a behind-display camera from capturing projected images. For example, a microlouver film is disposed on the back side of the glass substrate of the transparent display screen. The microlouver film provides light transmission blockage at angles greater than 30° for observers to the sides of the user. In other words, the microlouver film effectively blacks out viewing outside a 60-degree viewing angle relative to the center axis of the display screen. The microlouver film can be 3M's Advanced Light Control Film (ALCF-P ABRO). The camera 2330 is aimed along the center axis of the display screen, and it can be seen straight through the display screen.

A non-obvious application of the microlouver film is to use it to prevent transmission of the projected image sourced by the projector 2310. In this embodiment of the invention, the center optical axis of the projector 2310 is oriented outside the 60-degree viewing angle. The projected image is reflected by the reflective layer for user viewing. However, the microlouver film prevents transmission of the projected image, thus preventing the camera 2330 from capturing the projected image. The image of the user and the user's surroundings (as appearing within the 60-degree viewing angle) can be transmitted through the microlouver film and be seen by the camera 2330. Such a system provides a novel technique for eliminating the projector's projected image in an image captured by the camera.

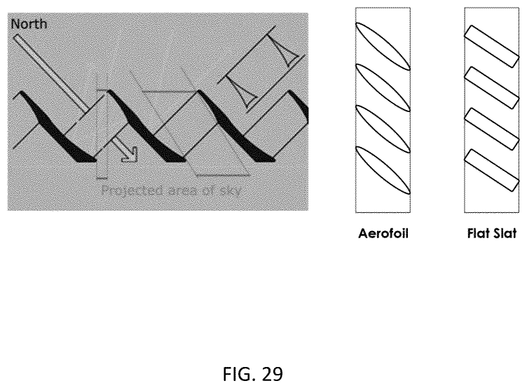

FIG. 29 illustrates various louver configurations used in the microlouver film incorporated into the transparent projection display system. In particular, the louvers may be either aerofoil-shaped or flat slat structures. Aerofoil louvers are designed with a curved, airfoil-like cross-section, which can optimize the directionality of light transmission and minimize unwanted scattering or diffraction, thereby enhancing clarity for the camera positioned along the central axis of the display. Flat slat louvers are formed as thin, planar vanes extending across the film's width and providing a sharply defined cutoff angle for transmitted light. Both louvers are typically oriented perpendicular to the display surface and are constructed from light-absorbing materials to maximize their effectiveness in blocking light at oblique angles. The choice between aerofoil and flat slat louvers, or a combination thereof, allows the microlouver film to be tailored for specific optical performance requirements, such as adjusting the width of the viewing angle, enhancing privacy, or further suppressing transmission of the projected image to the behind-display camera. By employing these different louver geometries, the system achieves selective light transmission: the camera can capture clear images of the user and their surroundings within the designated viewing angle, while the projected image and stray ambient light from outside this angle are effectively blocked. This versatility in louver design is critical for optimizing user privacy and camera image quality in advanced transparent display applications.

The invention has been described herein using specific embodiments for illustration only. However, it will be readily apparent to one of ordinary skill in the art that the invention's principles can be embodied in other ways. Therefore, the invention should not be regarded as limited in scope to the specific embodiments disclosed herein; it should be fully commensurate in scope with the following claims.

We claim:

1. A transparent projection display system comprising:
a display screen;
a reflective layer disposed on a front side of the display screen;
a microlouver film disposed on a rear side of the display screen;
a video projector disposed on a front side of the display screen and configured to project an image onto the display screen; and
a camera disposed behind the display screen and aimed along a center axis of the display screen.

2. The system of claim 1, wherein the microlouver film comprises an array of louvers configured to block transmission of light through the display screen at angles greater than 30 degrees relative to the center axis of the display screen.

3. The system of claim 1, wherein the microlouver film substantially prevents, to a human's perception, transmission of the projected image to the camera while permitting transmission of light from a user positioned in front of the display screen.

4. The system of claim 1, wherein the microlouver film provides a viewing angle of approximately 60 degrees centered about the center axis of the display screen.

5. The system of claim 1, wherein the louvers of the microlouver film are aerofoil-shaped or flat slat-shaped.

6. The system of claim 1, wherein the louvers are formed from a light-absorbing material.

7. The system of claim 1, wherein the projector is oriented such that its optical axis is outside the 60-degree viewing angle of the microlouver film.

8. The system of claim 1, wherein the camera is configured to capture video of the user without capturing the projected image.

9. The system of claim 1, wherein the microlouver film blocks at least 90% of light at angles greater than 30 degrees from the center axis.

10. A method of operating a transparent projection display system, comprising the steps of:
projecting an image onto a display screen using a video projector disposed on a front side of the screen;
reflecting the projected image toward a user by a reflective layer disposed on a front side of the display screen;
blocking transmission of the projected image through the display screen to a camera disposed behind the screen by providing a microlouver film on a rear side of the display screen, the microlouver film comprising an array of louvers configured to block light transmission at angles greater than 30 degrees from a center axis;
orienting the projector such that its optical axis is outside the viewing angle permitted by the microlouver film; and
capturing, with the camera, an image of a user positioned in front of the display screen through the microlouver film, while substantially preventing the projected image from being captured by the camera.

11. The method of claim 10, wherein the microlouver film has louvers selected from the group consisting of aerofoil louvers and flat slat louvers.

12. The method of claim 10, further comprising providing a viewing angle of approximately 60 degrees by the microlouver film.

13. The method of claim 10, wherein the camera is aligned along the center axis of the display screen.

14. The method of claim 10, wherein the reflective layer comprises a multilayer dielectric coating or a metal or alloy coating.

15. The method of claim 10, further comprising embedding the captured image of the user with the projected content for video conferencing.

16. A transparent projection display system comprising:
a display screen;
a reflective layer disposed on a front side of the transparent display screen;
a microlouver film disposed on a rear side of the transparent display screen, the microlouver film comprising louvers selected from the group consisting of aerofoil louvers and flat slat louvers, configured to block transmission of light at angles greater than 30 degrees from a center axis;
a video projector disposed such that its optical axis is outside the viewing angle permitted by the microlouver film and configured to project an image onto the transparent display screen; and
a camera disposed behind the transparent display screen and aligned along the center axis, the camera configured to capture an image of a user in front of the display screen while substantially preventing capture of the projected image.

17. The system of claim 16, wherein the louvers are formed from a light-absorbing material embedded in a transparent substrate.

18. The system of claim 16, wherein the microlouver film is laminated onto the transparent display screen using an optically clear adhesive.

19. The system of claim 16, further comprising a controller configured to synchronize operation of the projector and the camera for video conferencing applications.

20. The system of claim 16, wherein the reflective layer is configured to maximize brightness of the projected image for the user while maintaining transparency for the camera.
